(19) United States
(12) Patent Application Publication
(10) Pub. No.: US 2016/0329014 A1
(43) Pub. Date: Nov. 10, 2016

(54) DISPLAY DEVICE

(71) Applicant: SAMSUNG DISPLAY CO., LTD., Yongin-si (KR)

(72) Inventor: Dong-Hwan Lee, Yongin-si (KR)

(21) Appl. No.: 14/850,842

(22) Filed: Sep. 10, 2015

(30) Foreign Application Priority Data
May 7, 2015 (KR) 10-2015-0063618

(51) Int. Cl. G09G 3/20

(52) U.S. Cl. CPC G09G 3/2096; G09G 2330/021

(57) ABSTRACT

A display device includes a display panel including a plurality of scan lines, a plurality of data lines, and a plurality of pixels; a scan driver including first through (N)th stages configured to provide a scan signal to the pixels via the scan lines, where N is an integer greater than 1; a data driver configured to provide a data signal to the pixels via the data lines; and a controller configured to select a normal driving mode or a power saving mode as a panel driving mode for driving the display panel, and to control the scan driver and the data driver based on the panel driving mode, wherein the first through (N)th stages progressively output the scan signal in the normal driving mode, and at least two of the first through (N)th stages simultaneously output the scan signal in the power saving mode.

### CROSS REFERENCE TO RELATED APPLICATION

This application claims priority to and the benefit of Korean patent Application No. 10-2015-0063618 filed on May 7, 2015, the disclosure of which is incorporated by reference herein in its entirety.

### BACKGROUND

1. Field

Example embodiments of the inventive concept relate to display devices.

2. Description of the Related Art

Flat panel display (FPD) devices are widely used as a display device for electronic devices because FPD devices are relatively lightweight and thin compared to cathode-ray tube (CRT) display devices. Examples of FPD devices are liquid crystal display (LCD) devices, plasma display panel (PDP) devices, and organic light emitting display (OLED) devices.

Generally, a display device includes a display panel and a panel driver. The display panel includes a plurality of scan lines, a plurality of data lines, and a plurality of pixels. The panel driver typically includes a scan driver providing a scan signal to the pixels and a data driver providing a data signal to the pixels. Each of the pixels includes a plurality of sub-pixels that are arranged at locations corresponding to crossing points of the scan lines and the data lines, and receive the scan signal and the data signal to display the image. The power consumption of a high resolution display device is relatively high because the high resolution display device processes high quality images.

### SUMMARY

Example embodiments provide a display device capable of reducing power consumption.

According to some example embodiments, a display device may include a display panel including a plurality of scan lines, a plurality of data lines, and a plurality of pixels, a scan driver including first through (N)th stages providing a scan signal to the pixels via the scan lines, where N is an integer greater than 1, a data driver configured to provide a data signal to the pixels via the data lines, and a controller configured to select a normal driving mode or a power saving mode as a panel driving mode for driving the display panel, and to control the scan driver and the data driver based on the panel driving mode. The first through (N)th stages may progressively output the scan signal in the normal driving mode, and at least two of the first through (N)th stages simultaneously output the scan signal in the power saving mode.

In example embodiments, the first through (N)th stages may belong to a first stage group or a second stage group. Stages included in each of the first stage group or the second stage group may be dependently connected to each other.

In example embodiments, the first stage group may include odd number stages among the first through (N)th stages. The second stage group may include even number stages among the first through (N)th stages.

In example embodiments, a (2K−1) stage and a (2K) stage may simultaneously output the scan signal in the power saving mode, where K is an integer between 1 and N/2.

In example embodiments, a first stage may receive a first start signal. A second stage may receive a second start signal. The first start signal and the second start signal may be outputted at a different time in the normal driving mode, and may be outputted at a same time in the power saving mode.

In example embodiments, the second start signal may be substantially the same as an output signal of the first stage in the normal driving mode, and may be substantially the same as the first start signal in the power saving mode.

In example embodiments, the data driver may generate the data signal based on an average of a first image data corresponding to odd number scan lines among the scan lines and a second image data corresponding to even number scan lines among the scan lines in the power saving mode to provide the data signal to the data lines.

In example embodiments, the data driver may generate the data signal based on one of a first image data corresponding to odd number scan lines among the scan lines and a second image data corresponding to even number scan lines among the scan lines in the power saving mode to provide the data signal to the data lines.

In example embodiments, the data driver may output the data signal via a plurality of regular output terminals and a plurality of selective output terminals in the normal driving mode, and may output the data signal via the regular output terminals in the power saving mode.

In example embodiments, the regular output terminals and the selective output terminals may be alternatively arranged by a pixel unit.

In example embodiments, the data driver may provide the data signal to the data lines corresponding to the selective output terminals via the regular output terminals adjacent to the selective output terminals, respectively, in the power saving mode.

In example embodiments, the controller may include a driving mode selector configured to select the normal driving mode or the power saving mode as the panel driving mode, and a control signal provider configured to generate a control signal corresponding to the panel driving mode, and to provide the control signal to the scan driver and the data driver.

In example embodiments, the controller may further include an image data analyzer configured to derive a resolution from image data. The driving mode selector may select the power saving mode as the panel driving mode when the resolution is less than a predetermined threshold value, and may select the normal driving mode as the panel driving mode when the resolution is greater than or equal to the threshold value.

In example embodiments, the driving mode selector may receive power saving information, and determines the panel driving mode based on the power saving information.

In example embodiments, the control signal provider may provide a first scan clock signal to the scan driver in the normal driving mode, and provides a second scan clock signal to the scan driver in the power saving mode. A period of the second scan clock signal may be about two times greater than a period of the first scan clock signal.

According to some example embodiments, a display device may include a display panel including a plurality of scan lines, a plurality of data lines, and a plurality of pixels, a scan driver configured to provide a scan signal to the pixels via the scan lines, a data driver configured to provide a data signal to the pixels via the data lines, and a controller configured to select a normal driving mode or a power saving mode as a panel driving mode for driving the display panel, and to control the scan driver and the data driver based on the panel driving mode. The data driver may output the data signal via a plurality of regular output terminals and a plurality of selective output terminals in the normal driving mode, and may output the data signal via the regular output terminals in the power saving mode.

In example embodiments, the regular output terminals and the selective output terminals may be alternatively arranged by a pixel unit.

In example embodiments, the data driver may provide the data signal to the data lines corresponding to the selective output terminals via the regular output terminals adjacent to the selective output terminals, respectively, in the power saving mode.

According to some example embodiments, a display device may include a display panel divided into a normal display region and an additional display region, and including a plurality of normal scan lines located in the normal display region, a plurality of additional scan lines located in the additional display region, a plurality of data lines, and a plurality of pixels, a first scan driver including a plurality of normal stages providing a scan signal to the pixels via the normal scan lines, a second scan driver including first through (N)th additional stages providing the scan signal to the pixels via the additional scan lines, where N is an integer greater than 1, a data driver configured to provide a data signal to the data lines, and a controller configured to select a normal driving mode or a power saving mode as a panel driving mode for driving the display panel, and to control the first scan driver, the second scan driver, and the data driver based on the panel driving mode. The first through (N)th additional stages may progressively output the scan signal in the normal driving mode, and a (2K−1) additional stage and a (2K) additional stage may simultaneously output the scan signal in the power saving mode, where K is an integer between 1 and N/2.

In example embodiments, a first additional stage may receive a first carry signal from a last stage of the normal stages. A second additional stage may receive the first carry signal in the power saving mode, and may receive a second carry signal from the first additional stage in the normal driving mode.

Therefore, a display device according to example embodiments displays the image with relatively high resolution in the normal driving mode, and displays the image with relatively low resolution in the power saving mode. The scan signal is shared between adjacent scan lines, or the data signal is shared between adjacent data lines in the power saving mode. In result, the display device can reduce the power consumption while minimizing degradation of image quality.

### BRIEF DESCRIPTION OF THE DRAWINGS

Exemplary embodiments will be described more fully hereinafter with reference to the accompanying drawings, in which various embodiments are shown.

FIG. 1 is a block diagram illustrating a display device according to one example embodiment.

FIG. 2 is a block diagram illustrating an example of a controller included in a display device of FIG. 1.

FIG. 3 is a block diagram illustrating an example of a scan driver included in a display device of FIG. 1.

FIG. 4A is a waveform illustrating scan and data signals in a normal driving mode.

FIG. 4B is a waveform illustrating scan and data signals in a power saving mode.

FIG. 5 is a diagram for describing that power consumption of a display device of FIG. 1 is reduced in a power saving mode.

FIG. 6A is a diagram illustrating one example of a data driver and a display panel included in a display device of FIG. 1.

FIG. 6B is a diagram illustrating another example of a data driver and a display panel included in a display device of FIG. 1.

FIG. 7 is a diagram for describing that power consumption of a display device of FIG. 1 is reduced in a power saving mode.

FIG. 8 is a block diagram illustrating a display device according to another example embodiment.

FIG. 9 is a block diagram illustrating an example of first and second scan drivers included in a display device of FIG. 8.

FIG. 10 is a diagram for describing that power consumption of a display device of FIG. 8 is reduced in a power saving mode.

### DETAILED DESCRIPTION

Exemplary embodiments will be described more fully hereinafter with reference to the accompanying drawings, in which various embodiments are shown.

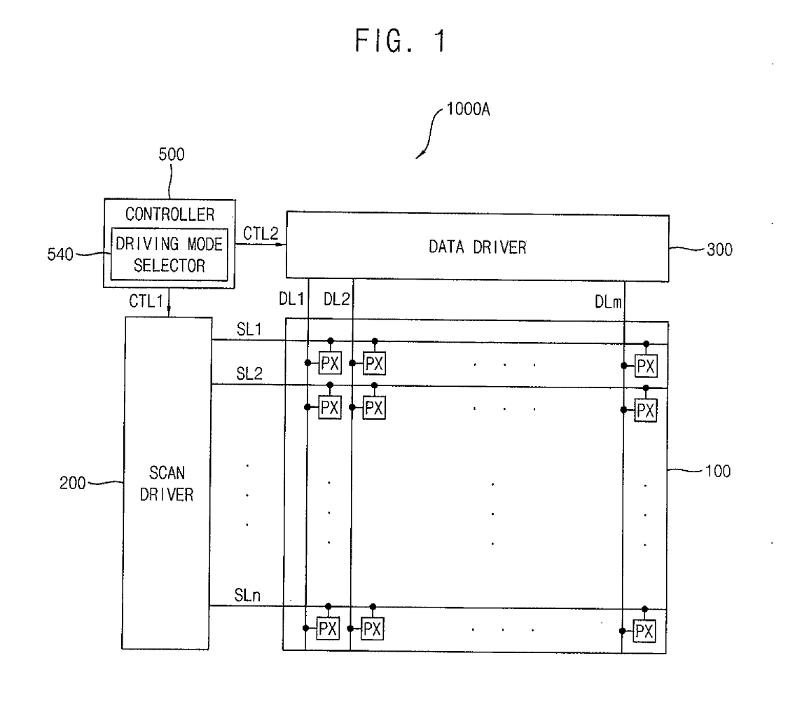

FIG. 1 is a block diagram illustrating a display device according to one example embodiment.

Referring to FIG. 1, the display device 1000A may include a display panel 100, a scan driver 200, a data driver 300, and a controller 500.

The display panel 100 is configured to display an image. The display panel 100 may include a plurality of scan lines SL1 through SLn, a plurality of data lines DL1 through DLm, and a plurality of pixels. Each of the pixels may include a plurality of sub-pixels PX. For example, the display panel 100 may include n*m sub-pixels PX because the sub-pixels PX are arranged at locations corresponding to crossing points of the scan lines SL1 through SLn and the data lines DL1 through DLm.

The scan driver 200 may provide the scan signal to the pixels via the scan lines SL1 through SLn based on the first control signal CTL1. In one example embodiment, the scan driver 200 may include first through (N)th stages providing the scan signal to the pixels via the scan lines SL1 through SLn, respectively. The first through (N)th stages may progressively output the scan signal in the normal driving mode. At least two of the first through (N)th stages may simultaneously output the scan signal in the power saving mode. For example, the first through (N)th stages may be grouped by adjacent two stages in the power saving mode, and stages included in the same group may simultaneously output the scan signal. Thus, the scan signal may be shared between adjacent scan lines in the power saving mode to reduce power consumption. Hereinafter, the scan driver 200 will be described in more detail with reference to the FIG. 3.

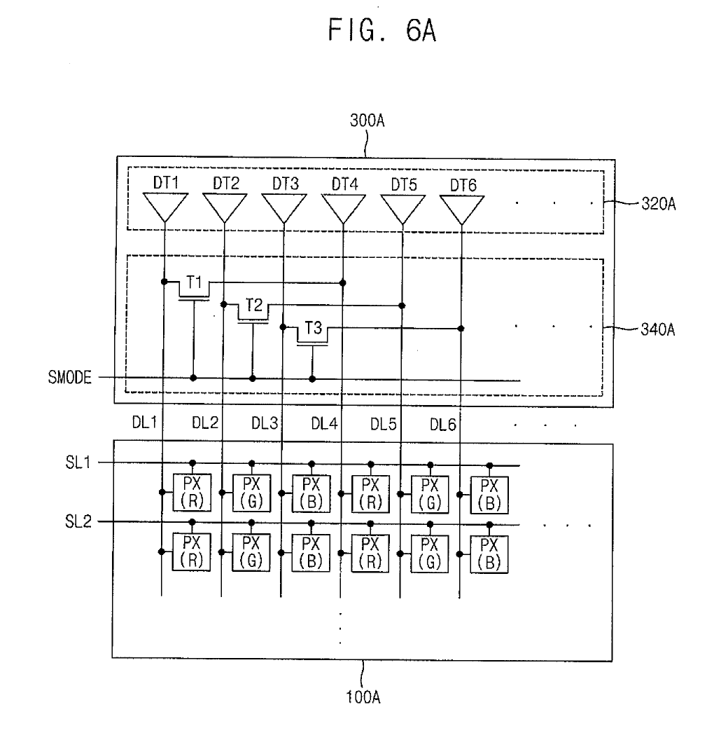

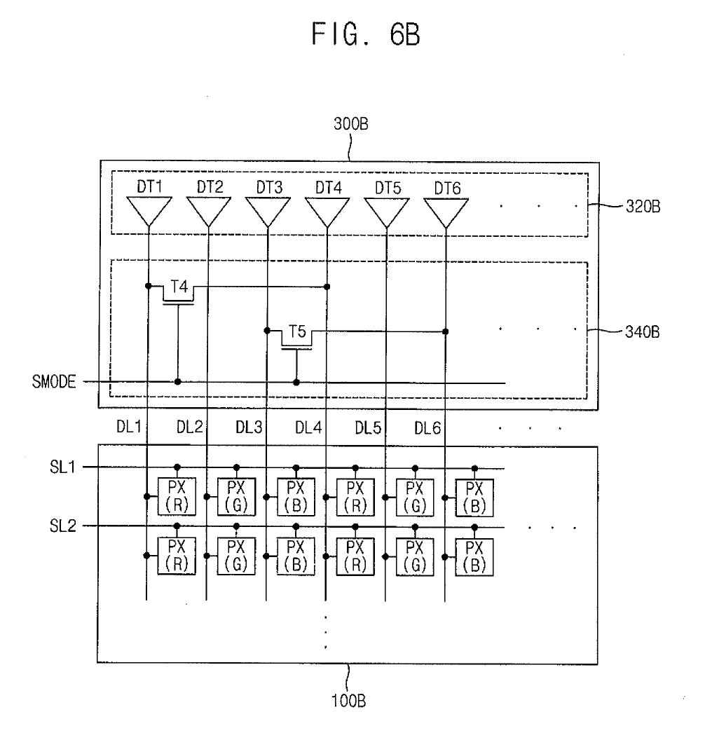

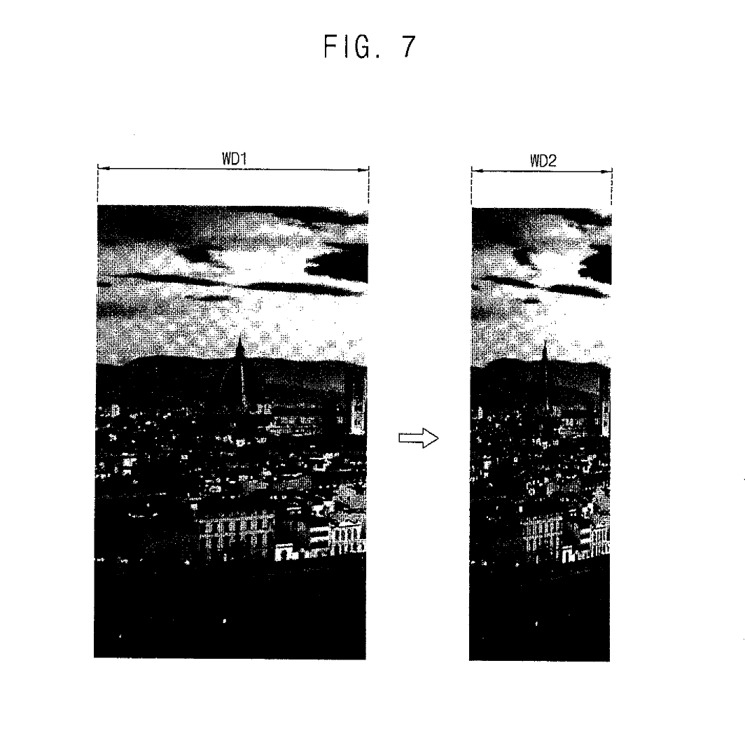

The data driver 300 may provide a data signal to the pixels via the data lines DL1 through DLm based on the second control signal CTL2. In one example embodiment, the data driver 300 may generate the data signal based on an average of image data for adjacent scan lines or based on image data for odd number scan lines in the power saving mode because the scan signal is shared between adjacent scan lines in the power saving mode. In one example embodiment, the data driver 300 may output the data signal via a plurality of regular output terminals and a plurality of selective output terminals in the normal driving mode, and may output the data signal via the regular output terminals in the power saving mode. For example, the data driver 300 may provide the data signal to the data lines corresponding to the selective output terminals via regular output terminals adjacent to the selective output terminals in the power saving mode. Hereinafter, the data driver 300 will be described in more detail with reference to the FIGS. 6A and 6B.

The controller 500 may select a normal driving mode or a power saving mode as a panel driving mode for driving the display panel 100 by including a driving mode selector 540. The display device 1000A may display the image with relatively high resolution in the normal driving mode, and may display the image with relatively low resolution in the power saving mode. The controller 500 may select one of the normal driving mode or the power saving mode as the panel driving mode to adjust the resolution of the displayed image depend on the situation. For example, when the battery for the display device 1000A is low, the controller 500 may select the power saving mode as the panel driving mode to reduce power consumption. Also, when resolution of image data is lower than a predetermined threshold value, the controller 500 may select the power saving mode as the panel driving mode to reduce power consumption.

The controller 500 may control the scan driver 200 and the data driver 300 based on the panel driving mode. The controller 500 may generate the first and second control signals CTL1 and CTL2 to control the scan driver 200 and the data driver 300.

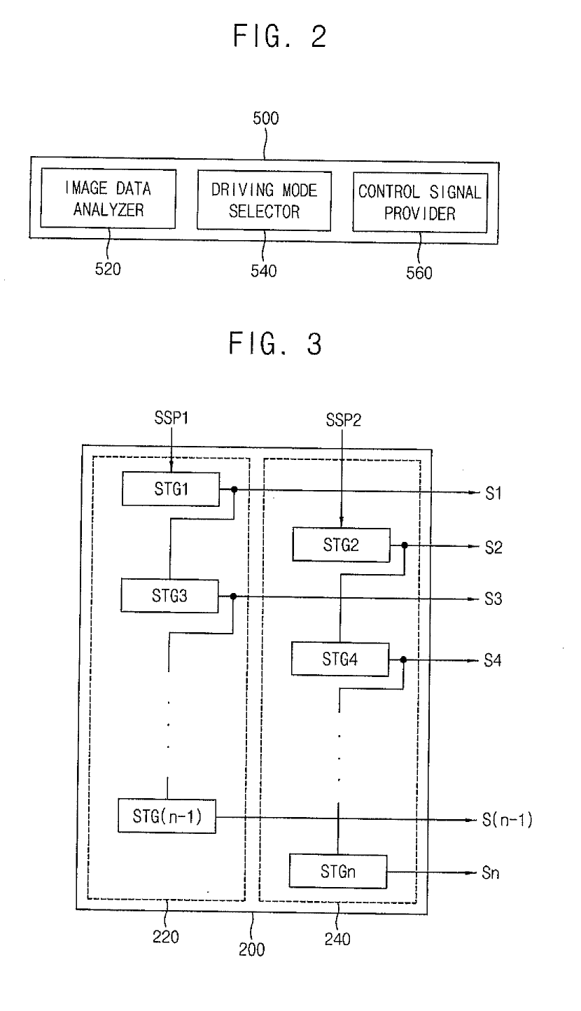

Hereinafter, the controller 500 will be described in more detail with reference to the FIG. 2.

Therefore, the display device 1000A may display the image with relatively high resolution in the normal display mode, and may display the image with relatively low resolution in the power saving display mode. Thus, the scan signal is shared between adjacent scan lines or the data signal is shared between adjacent data lines in the power saving mode. Accordingly, the display device 1000A can reduce the power consumption while minimizing degradation of display quality.

FIG. 2 is a block diagram illustrating an example of a controller included in a display device of FIG. 1.

Referring to FIG. 2, the controller 500 may include an image data analyzer 520, a driving mode selector 540, and a control signal provider 560.

The image data analyzer 520 is configured to derive information for determining the panel driving mode by analyzing the image data. In one example embodiment, the image data analyzer 520 may derive a resolution of the image data to determine the panel driving mode based on the resolution of the image data. In another example embodiment, the image data analyzer 520 may derive a grayscale distribution of the image data to determine the panel driving mode based on the grayscale distribution.

The driving mode selector 540 may select the normal driving mode or the power saving mode as the panel driving mode.

In one example embodiment, the driving mode selector 540 may select the power saving mode as the panel driving mode when the resolution is less than a predetermined threshold value, and may select the normal driving mode as the panel driving mode when the resolution is greater than or equal to the threshold value. For example, when the display device supports the ultra high definition (UHD) and the resolution of the image data corresponds to the full high definition (FHD), the driving mode selector 540 may select the power saving mode to reduce the power consumption. In this case, although the display device is driven in the power saving mode, the degradation of the display quality cannot be recognized by a user.

In another example embodiment, when a dispersion of the grayscale distribution of the image data is smaller than a predetermined value, the driving mode selector 540 may select the power saving mode as the panel driving mode. On the other hand, when a dispersion of the grayscale distribution of the image data is larger than or equal to the predetermined value, the driving mode selector 540 may select the normal driving mode as the panel driving mode. Thus, the driving mode selector 540 may select the power saving mode when the dispersion of the grayscale distribution is relatively small. In this case, although the display device is driven in the power saving mode, the degradation of the display quality cannot be recognized by the user.

In still another example embodiment, the driving mode selector 540 may receive the power saving information from the outside, and may determine the panel driving mode based on the power saving information. For example, when the battery for the display device 1000A is low, the driving mode selector 540 may receive the power saving information, and select the power saving mode as the panel driving mode.

The control signal provider 560 is configured to provide a first control signal to the scan driver so that the scan driver outputs the scan signal corresponding to the panel driving mode. The first control signal may include a driving mode signal, scan clock signals, a vertical start signal, etc. In one example embodiment, the control signal provider 560 may provide a first scan clock signal to the scan driver in the normal driving mode, and may provide a second scan clock signal to the scan driver in the power saving mode. A period of the second scan clock signal can be adjusted. For example, a period of the second scan clock signal may be about two times greater than a period of the first scan clock signal. In this case, the power consumption can be reduced by decreasing the clock frequency by half in the power saving mode. On the other hand, when the first scan clock signal is substantially the same as the second scan clock signal, the flicker can be reduced because the charging time can be secured and the display device can be driven in high frequency.

The control signal provider 560 is configured to provide a second control signal to the data driver so that the data driver outputs the data signal corresponding to the panel driving mode. The second control signal may include the driving mode signal, a load signal, a horizontal start signal, image data, etc. The control signal provider 560 may adjust a period of the load signal or image data to drive the display panel in the power saving mode.

FIG. 3 is a block diagram illustrating an example of a scan driver included in a display device of FIG. 1.

Referring to FIG. 3, the scan driver 200 may include first through (N)th stages STG1 through STGn providing a scan signal to the pixels via the scan lines. The first through (N)th stages STG1 through STGn may belong to a first stage group 220 or a second stage group 240. For example, the first stage group 220 may include odd number stages STG1, STG3, etc that are dependently connected to each other and the second stage group 240 may include even number stages STG2, STG4, etc that are dependently connected to each other.

The first through (N)th stages STG1 through STGn progressively output the scan signal in the normal driving mode. The first stage STG1 may receive a first start signal SSP1, and the second stage STG2 may receive a second start signal SSP2. The first start signal SSP1 and the second start signal SSP2 may be outputted at a different time in the normal driving mode. For example, the second start signal SSP2 may be substantially the same as an output signal of the first stage STG1 in the normal driving mode. Therefore, the scan driver 200 may progressively provide first through (N)th scan signals S1 through Sn to the display panel in the normal driving mode, thereby displaying the image with relatively high resolution.

On the other hand, the (2K−1) stage and the (2K) stage simultaneously output the scan signal in the power saving mode, where K is an integer between 1 and N/2. Thus, the first through (N)th stages STG1 through STGn may be grouped by adjacent two stages in the power saving mode, and stages included in the same group simultaneously output the scan signal. The first start signal SSP1 and the second start signal SSP2 may be outputted simultaneously in the power saving mode. For example, the second start signal SSP2 may be substantially the same as the first start signal in the power saving mode. Therefore, the scan signal is shared between adjacent scan lines in the power saving mode, thereby displaying image with relatively low resolution and reducing the power consumption.

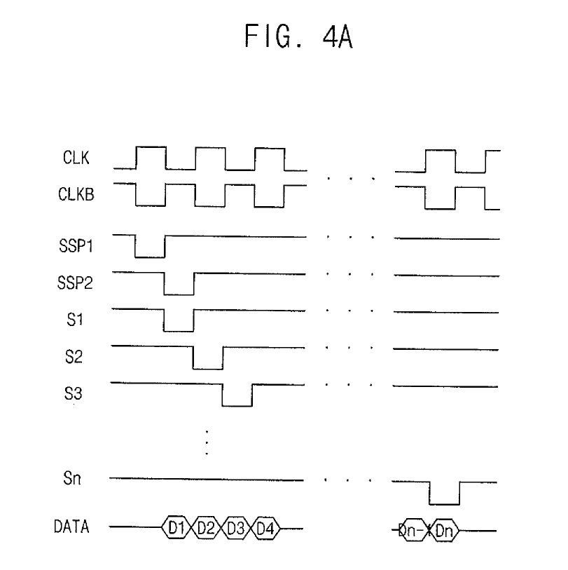

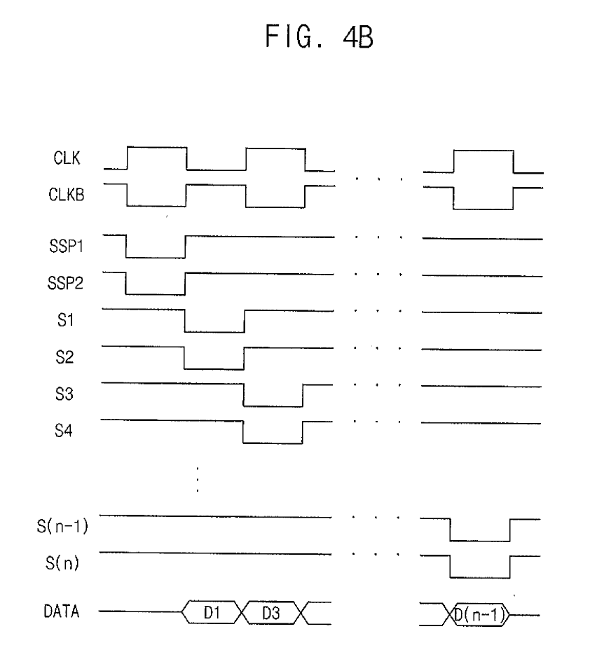

FIG. 4A is a waveform illustrating scan and data signals in a normal driving mode. FIG. 4B is a waveform illustrating scan and data signals in a power saving mode.

Referring to FIGS. 4A and 4B, a scan driver may progressively provide the scan signal to the display panel in the normal driving modem, thereby displaying the image with relatively high resolution. On the other hand, the scan signal may be shared between adjacent scan lines in the power saving mode, thereby displaying the image with relatively low resolution.

As shown in FIG. 4A, the first start signal SSP1 and the second start signal SSP2 may be outputted at a different time in the normal driving mode. The second start signal SSP2 may be substantially the same as an output signal (i.e., a first scan signal S1) of the first stage STG1 in the normal driving mode. Therefore, first through (N)th scan signals S1 through Sn may be progressively outputted in the normal driving mode. In this case, first through (N)th data signals corresponding to the first through (N)th scan lines may be progressively outputted to the data lines.

As shown in FIG. 4B, the second start signal SSP2 may be substantially the same as the first start signal SSP1 in the power saving mode. Therefore, the (2K−1)th scan signal and the (2K)th scan signal may be outputted at a same time in the power saving mode.

The data signals may be applied to the data lines based on the scan signal. In one example embodiment, the data driver may generate the data signal based on an average of a first image data corresponding to odd number scan lines among the scan lines and a second image data corresponding to even number scan lines among the scan lines in the power saving mode to provide the data signal to the data lines. For example, the data driver calculate the average of image data corresponding to the first scan line and image data corresponding to the second scan line, and generate the data signal based on the average. The data driver may provide the data signal to the data line when the first and second scan signals are applied to the scan lines. In this case, distortion of image generated by displaying image with relatively low resolution in the power saving mode can be decreased. In another example embodiment, the data driver may generate the data signal based on one of a first image data corresponding to odd number scan lines among the scan lines and a second image data corresponding to even number scan lines among the scan lines in the power saving mode to provide the data signal to the data lines. For example, the data signal corresponding to the first scan line may be applied to the data line when the first and second scan signals S1 and S2 may be applied to the scan lines. In this case, load of the display device can be decreased because the average of the first image data and the second image data is not need to be calculated.

A period of the scan clock signals applied to the scan driver may be adjusted according to the panel driving mode. In one example embodiment, a period of the second scan clock signal is about two times greater than a period of the first scan clock signal. Thus, because the scan signal is shared between adjacent scan lines in the power saving mode, the period of the second scan clock signal may be set relatively large to reduce the power consumption.

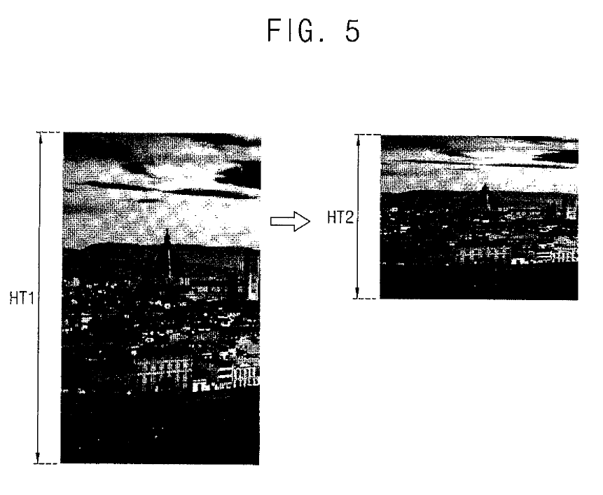

FIG. 5 is a diagram for describing that power consumption of a display device of FIG. 1 is reduced in a power saving mode.

Referring to FIG. 5, in the normal driving mode, a scan driver may progressively output a scan signal, and a data driver may output a data signal corresponding to the scan signal. Therefore, the data signal corresponding to the original image data having a first height HT1 can be outputted in the normal driving mode.

On the other hand, in the power saving mode, adjacent two stages in the scan driver may be grouped, and stages included in the same group may simultaneously output the scan signal. In addition, the data driver may generate the data signal based on an average of data signals corresponding to adjacent scan lines or based on image data for odd number scan lines. Therefore, the data signal corresponding to the altered image data having a second height HT2 smaller than the first height HT1 can be outputted in the power saving mode. For example, when the stages included in the scan driver are grouped by adjacent two stages, the first height HT1 may be about two times greater than the second height HT2.

Therefore, the size of image data processed within one frame can be decreased in the power saving mode to reduce the power consumption.

FIG. 6A is a diagram illustrating one example of a data driver and a display panel included in a display device of FIG. 1. FIG. 6B is a diagram illustrating another example of a data driver and a display panel included in a display device of FIG. 1.

Referring to FIGS. 6A and 6B, the data driver 300A/300B may include an output buffer 320A/320B and a line controller 340A/340B. The output buffer 320A/320B may include a plurality of regular output terminals and a plurality of selective output terminals. The line controller 340A/340B may control a connection between the output terminals and the data lines. The data driver 300A/300B may output the data signal via the regular output terminals and the selective output terminals in the normal driving mode and may output the data signal via the regular output terminals in the power saving mode. The data driver 300A/300B may provide the data signal to the data lines corresponding to the selective output terminals via the regular output terminals adjacent to the selective output terminals in the power saving mode. Thus, in the power saving mode, a current may not flow through amplifiers connected to the selective output terminals, and the data signal may be shared between adjacent data lines, thereby reducing the power consumption.

As shown in FIG. 6A, the pixel may include a red color sub-pixel PX(R), a green color sub-pixel PX(G), and a blue color sub-pixel PX(B). The red color sub-pixels PX(R), the green color sub-pixels PX(G), and the blue color sub-pixels PX(B) may be arranged in a stripe type structure. The red color sub-pixels PX(R) may be connected to the first and fourth data lines DL1 and DL4. The green color sub-pixels PX(G) may be connected to the second and fifth data lines DL2 and DL5. The blue color sub-pixels PX(B) may be connected to the third and sixth data lines DL3 and DL6. The regular output terminals and the selective output terminals may be alternatively arranged by a pixel unit. For example, the first through third output terminals DT1 through DT3 included in the output buffer 320A may be regular output terminals, and the fourth through sixth output terminals DT4 through DT6 included in the output buffer 320A may be selective output terminals.

In the normal driving mode, the data driver 300A may provide the data signal to the first through sixth data lines DL1 through DL6 via the first through sixth output terminals DT1 through DT6, respectively. On the other hand, in the power saving mode, the data driver 300A may provide the data signal to the first and fourth data lines DL1 and DL4 via the first output terminal DT1, may provide the data signal to the second and fifth data lines DL2 and DL5 via the second output terminal DT2, and may provide the data signal to the third and sixth data lines DL3 and DL6 via the third output terminal DT3. In one example embodiment, the line controller 340A may include first through third transistors T1 through T3. The first transistor T1 may be connected between the first output terminal DT1 and the fourth output terminal DT4, and may be turned on in response to a driving mode signal SMODE. The second transistor T2 may be connected between the second output terminal DT2 and the fifth output terminal DT5, and may be turned on in response to the driving mode signal SMODE. The third transistor T3 may be connected between the third output terminal DT3 and the sixth output terminal DT6, and may be turned on in response to the driving mode signal SMODE. Therefore, in the power saving mode, a current may not flow through amplifiers connected to the selective output terminals (i.e., the fourth through sixth output terminals DT4 through DT6), and the driving mode signal SMODE is applied to the line controller 340A, thereby sharing the data signal between adjacent pixels.

As shown in FIG. 6B, the first, second, third and fifth output terminals DT1, DT2, DT3, and DT5 included in the output buffer 320B may be regular output terminals, and the fourth and sixth output terminals DT4 and DT6 may be selective output terminals.

In the normal driving mode, the data driver 300B may provide the data signal to the first through sixth data lines DL1 through DL6 via the first through sixth output terminals DT1 through DT6, respectively. On the other hand, in the power saving mode, the data driver 300B may provide the data signal to the first and fourth data lines DL1 and DL4 via the first output terminal DT1, may provide the data signal to the second data line DL2 via the second output terminal DT2, may provide the data signal to the third and sixth data lines DL3 and DL6 via the third output terminal DT3, and may provide the data signal to the fifth data line DL5 via the fifth output terminal DT5. In one example embodiment, the line controller 340B may include fourth and fifth transistors T4 and T5. The fourth transistor T4 may be connected between the first output terminal DT1 and the fourth output terminal DT4, and may be turned on in response to the driving mode signal SMODE. The fifth transistor T5 may be connected between the third output terminal DT3 and the sixth output terminal DT6, and may be turned on in response to a driving mode signal SMODE. Therefore, in the power saving mode, a current may not flow through amplifiers connected to the selective output terminals (i.e., the fourth and sixth output terminals DT4 and DT6), and the driving mode signal SMODE is applied to the line controller 340B, thereby sharing the data signal between adjacent pixels. In this case, because the amount of processed data signal corresponding to the red color sub pixels and the blue color sub pixels is decreased by half, the display panel 100B can be driven by a driving method for the display panel having the pentile type structure.

FIG. 7 is a diagram for describing that power consumption of a display device of FIG. 1 is reduced in a power saving mode.

Referring to FIG. 7, a data driver may output the data signal via a plurality of regular output terminals and a plurality of selective output terminals in the normal driving mode. Therefore, the data signal corresponding to the original image data having a first width WD1 can be outputted in the normal driving mode.

On the other hand, the data driver may output the data signal via the regular output terminals in the power saving mode. In this case, the data driver may provide the data signal to the data lines corresponding to the selective output terminals via the regular output terminals adjacent to the selective output terminals. Thus, the data signal may be shared between adjacent pixels. Therefore, the data signal corresponding to the altered image data having a second width WD2 smaller than the first width WD1 can be outputted in the power saving mode. For example, when the number of the regular output terminals is the same as the number of the selective output terminals, the first width WD1 may be two times greater than the second width WD2.

Therefore, the size of image data processed within one frame can be decreased in the power saving mode to reduce the power consumption.

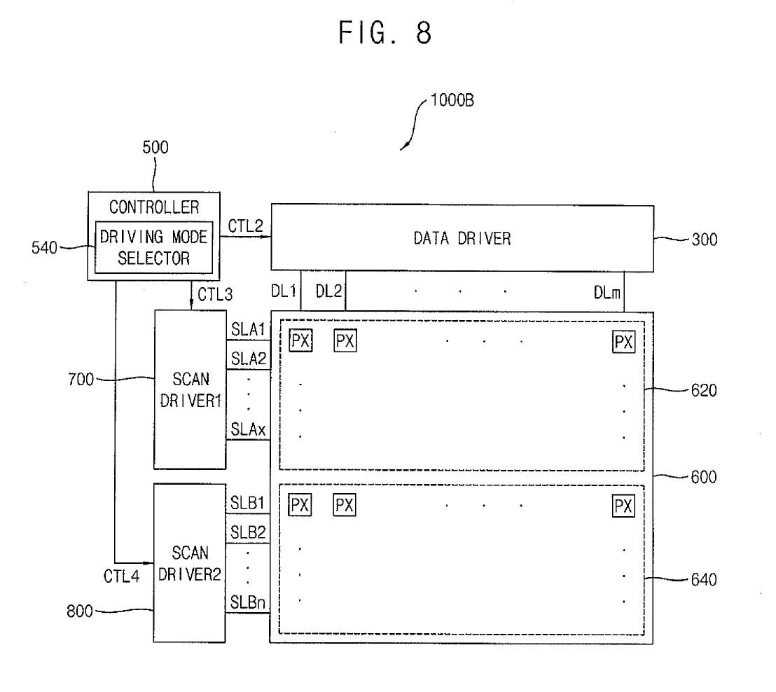

FIG. 8 is a block diagram illustrating a display device according to another example embodiment.

Referring to FIG. 8, the display device 1000B may include a display panel 600, a first scan driver 700, a second scan driver 800, a data driver 300, and a controller 500.

The display panel 600 may display an image. The display panel 600 may be divided into a normal display region 620 and an additional display region 640. In one embodiment, the additional display region 640 may be distinguished from the normal display region 620 such as a side display region of the smart phone, an edge display region of the smart phone, etc. The display panel 600 may include a plurality of normal scan lines SLA1 through SLAx located in the normal display region 620, a plurality of additional scan lines SLB1 through SLBn located in the additional display region 640, a plurality of data lines DL1 through DLm, and a plurality of pixels. For example, the display panel 600 may include (x+n)*m sub-pixels PX because the sub-pixels PX are arranged at locations corresponding to crossing points of the scan lines and the data lines DL1 through DLm.

The first scan driver 700 may include a plurality of normal stages providing a scan signal to the pixels via the normal scan lines SLA1 through SLAx.

The second scan driver 800 may include first through (N)th additional stages providing the scan signal to the pixels via the additional scan lines SLB1 through SLBn, where N is an integer greater than 1. The first through (N)th additional stages may progressively output the scan signal in the normal driving mode. At least two of the first through (N)th additional stages may simultaneously output the scan signal in the power saving mode. For example, the first through (N)th additional stages may be grouped by adjacent two additional stages in the power saving mode, and additional stages included in the same group simultaneously output the scan signal. Thus, the scan signal may be shared between adjacent additional scan lines in the power saving mode to reduce power consumption.

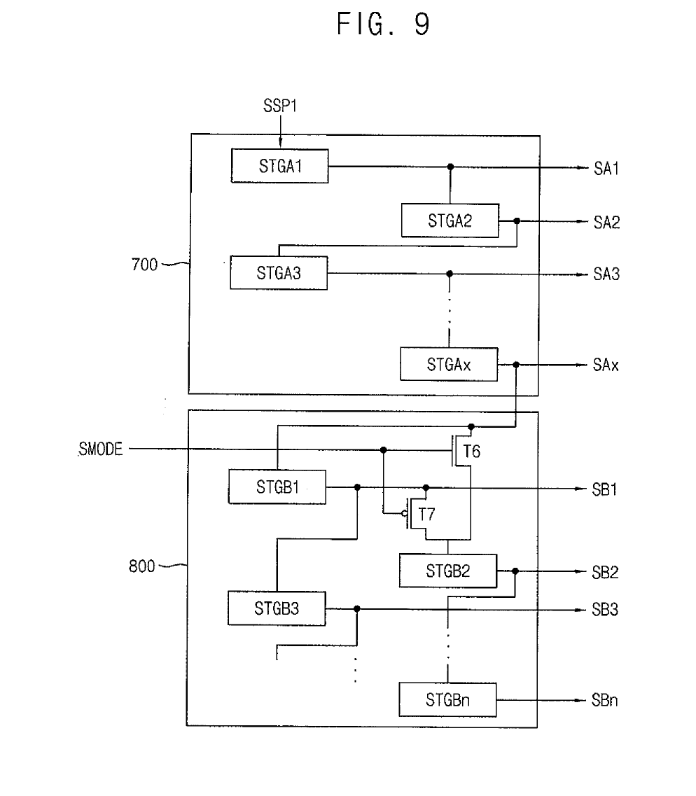

Hereinafter, the first scan driver 700 and the second scan driver 800 will be described in more detail with reference to the FIG. 9.

The data driver 300 may provide a data signal to the pixels via the data lines DL1 through DLm based on the second control signal CTL2. Since the data driver 300 is described above, duplicated descriptions will be omitted.

The controller 500 may select a normal driving mode or a power saving mode as a panel driving mode for driving the display panel 600. The controller 500 may control the first scan driver 700, the second scan driver 800, and the data driver 300 based on the panel driving mode. Since the controller 500 is described above, duplicated descriptions will be omitted.

Therefore, the scan signal may be shared between adjacent additional scan lines for the additional display region that is a portion of the display panel 600 in the power saving mode. Accordingly, because the display device 1000B displays the image for additional display region with relatively low resolution in the power saving mode, the display device 1000B can reduce the power consumption while minimizing degradation of display quality.

FIG. 9 is a block diagram illustrating an example of first and second scan drivers included in a display device of FIG. 8.

Referring to FIG. 9, a first scan driver 700 may include a plurality of normal scan stages providing the scan signal to the normal scan lines. For example, the first scan driver 700 may include first through (X)th normal stages STGA1 through STGAx that are dependently connected to each other. The first through (X)th normal stages STGA1 through STGAx may provide the scan signal to the first through (X)th normal scan lines, respectively. Thus, the first scan driver 700 may receive a first start signal SSP1, and may progressively output the scan signal as the shift register.

The second scan driver 800 may include the first through (N)th additional stages STGB1 through STGBn providing the scan signal to the pixels via the additional scan lines. The first additional stage STGB1 may receive a first carry signal from a last stage of the normal stages (i.e., the (X)th normal stage STGAx). The second additional stage STGB2 may receive a second carry signal from the first additional stage STGB1 in the normal driving mode, and may receive the first carry signal in the power saving mode. For example, the second scan driver 800 may include sixth and seventh transistors T6 and T7. The sixth transistor T6 may be connected between the (X)th normal stage STGAx and the second additional stage STGB2, and may be turned on in response to a driving mode signal SMODE. The seventh transistor T7 may be connected between the first additional stage STGB1 and the second additional stage STGB2, and may be turned off in response to a driving mode signal SMODE.

In the normal driving mode, the first through (N)th additional stages STGB1 through STGBn may progressively output the scan signal. The first additional stage STGB1 may receive the first carry signal from a last stage of the normal stages (i.e., the (X)th normal stage STGAx), the second additional stage STGB2 may receive the second carry signal from the first additional stage STGB1 in the normal driving mode. Therefore, the first scan driver 700 and the second scan driver 800 may progressively provide the first through (X)th normal scan signals SA1 through SAx and the first through (N)th additional scan signals SB1 through SBn, thereby displaying the image with relatively high resolution.

On the other hand, in the power saving mode, the (2K−1) additional stage and the (2K) additional stage may simultaneously output the scan signal in the power saving mode.

The first additional stage STGB1 and the second additional stage STGB2 may receive the first carry signal from the last stage of the normal stages (i.e., the (X)th normal stage STGAx). Thus, the first through (N)th additional stages STGB1 through STGBn may be grouped by adjacent two additional stages in the power saving mode, and the additional stages included in the same group may simultaneously output the scan signal. Therefore, the scan signal may be shared between adjacent additional scan lines in the power saving mode to display the image with relatively low resolution and to reduce power consumption.

Although the example embodiment of FIG. 9 describes that the second scan driver 800 includes the first through (N)th additional stages STGB1 through STGBn providing the first through (N)th additional scan signal SB1 through SBn to the first through (N)th additional scan lines, respectively, the second scan driver 800 may include the first through (N/2) additional stages, and the (K)th additional stage provides the scan signal to the (2K−1)th and (2K)th scan lines. In this case, because the number of the additional stages can be reduced, area of panel driver can be decreased.

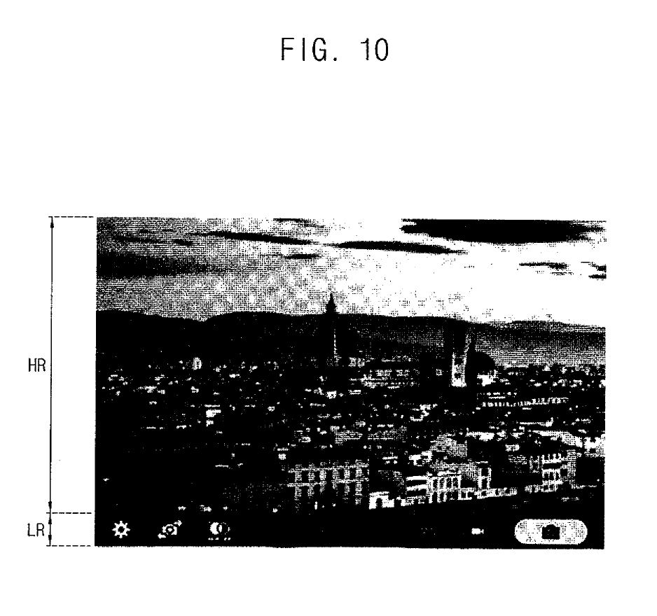

FIG. 10 is a diagram for describing that power consumption of a display device of FIG. 8 is reduced in a power saving mode.

Referring to FIG. 10, a display panel may be divided into a normal display region HR and an additional display region LR. The additional display region LR may be for displaying the additional information such as a side display region of the smart phone, an edge display region of the smart phone, etc. The additional display region LR may display the image with relatively low resolution in the power saving mode to reduce the power consumption. For example, in a camera mode for taking a picture, the display device may be driven in the power saving mode. The scan signal may be grouped between adjacent two additional scan lines in the power saving mode, the additional stages included in the same group simultaneously provide the scan signal to the additional display region LR. In addition, the data driver may generate the data signal based on an average of data signal corresponding to adjacent additional scan lines or may generate data signal corresponding to the odd number additional scan lines. Therefore, the size of image data processed within one frame can be decreased in the power saving mode to reduce the power consumption.

Although the example embodiments describe that the sub-pixels are arranged in the stripe type structure, it is not limited thereto.

The present inventive concept may be applied to an electronic device having the display device. For example, the present inventive concept may be applied to a cellular phone, a smart phone, a smart pad, a personal digital assistant (FDA), etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A display device comprising:
a display panel including a plurality of scan lines, a plurality of data lines, and a plurality of pixels;
a scan driver including first through (N)th stages configured to provide a scan signal to the pixels via the scan lines, where N is an integer greater than 1;
a data driver configured to provide a data signal to the pixels via the data lines; and
a controller configured to select a normal driving mode or a power saving mode as a panel driving mode for driving the display panel, and to control the scan driver and the data driver based on the panel driving mode,
wherein the first through (N)th stages progressively output the scan signal in the normal driving mode, and at least two of the first through (N)th stages simultaneously output the scan signal in the power saving mode.

2. The display device of claim 1, wherein the first through (N)th stages belong to a first stage group or a second stage group, and
wherein stages included in each of the first stage group or the second stage group are dependently connected to each other.

3. The display device of claim 2, wherein the first stage group includes odd number stages among the first through (N)th stages, and
wherein the second stage group includes even number stages among the first through (N)th stages.

4. The display device of claim 3, wherein a (2K−1) stage and a (2K) stage are configured to simultaneously output the scan signal in the power saving mode, where K is an integer between 1 and N/2.

5. The display device of claim 3, wherein a first stage is configured to receive a first start signal,
wherein a second stage is configured to receive a second start signal, and
wherein the first start signal and the second start signal are outputted at a different time in the normal driving mode, and are outputted simultaneously in the power saving mode.

6. The display device of claim 5, wherein the second start signal is substantially the same as an output signal of the first stage in the normal driving mode, and is substantially the same as the first start signal in the power saving mode.

7. The display device of claim 1, wherein the data driver is configured to generate the data signal based on an average of a first image data corresponding to odd number scan lines among the scan lines and a second image data corresponding to even number scan lines among the scan lines in the power saving mode to provide the data signal to the data lines.

8. The display device of claim 1, wherein the data driver is configured to generate the data signal based on one of a first image data corresponding to odd number scan lines among the scan lines and a second image data corresponding to even number scan lines among the scan lines in the power saving mode to provide the data signal to the data lines.

9. The display device of claim 1, wherein the data driver is configured to output the data signal via a plurality of regular output terminals and a plurality of selective output terminals in the normal driving mode, and is configured to output the data signal via the regular output terminals in the power saving mode.

10. The display device of claim 9, wherein the regular output terminals and the selective output terminals are alternatively arranged by a pixel unit.

11. The display device of claim 10, wherein the data driver is configured to provide the data signal to the data lines corresponding to the selective output terminals via the regular output terminals adjacent to the selective output terminals, respectively, in the power saving mode.

12. The display device of claim 1, wherein the controller includes:
a driving mode selector configured to select the normal driving mode or the power saving mode as the panel driving mode; and
a control signal provider configured to generate a control signal corresponding to the panel driving mode, and to provide the control signal to the scan driver and the data driver.

13. The display device of claim 12, wherein the controller further includes:
an image data analyzer configured to derive a resolution from image data,
wherein the driving mode selector selects the power saving mode as the panel driving mode when the resolution is less than a predetermined threshold value, and selects the normal driving mode as the panel driving mode when the resolution is greater than or equal to the threshold value.

14. The display device of claim 12, wherein the driving mode selector is configured to receive power saving information, and determines the panel driving mode based on the power saving information.

15. The display device of claim 12, wherein the control signal provider is configured to provide a first scan clock signal to the scan driver in the normal driving mode, and is configured to provide a second scan clock signal to the scan driver in the power saving mode, and
wherein a period of the second scan clock signal is about two times greater than a period of the first scan clock signal.

16. A display device comprising:
a display panel including a plurality of scan lines, a plurality of data lines, and a plurality of pixels;
a scan driver configured to provide a scan signal to the pixels via the scan lines;
a data driver configured to provide a data signal to the pixels via the data lines; and
a controller configured to select a normal driving mode or a power saving mode as a panel driving mode for driving the display panel, and to control the scan driver and the data driver based on the panel driving mode,
wherein the data driver is configured to output the data signal via a plurality of regular output terminals and a plurality of selective output terminals in the normal driving mode, and is configured to output the data signal via the regular output terminals in the power saving mode.

17. The display device of claim 16, wherein the regular output terminals and the selective output terminals are alternatively arranged by a pixel unit.

18. The display device of claim 17, wherein the data driver is configured to provide the data signal to the data lines corresponding to the selective output terminals via the regular output terminals adjacent to the selective output terminals, respectively, in the power saving mode.

19. A display device comprising:
a display panel divided into a normal display region and an additional display region, and including a plurality of normal scan lines located in the normal display region, a plurality of additional scan lines located in the additional display region, a plurality of data lines, and a plurality of pixels;
a first scan driver including a plurality of normal stages providing a scan signal to the pixels via the normal scan lines;
a second scan driver including first through (N)th additional stages providing the scan signal to the pixels via the additional scan lines, where N is an integer greater than 1;
a data driver configured to provide a data signal to the data lines; and
a controller configured to select a normal driving mode or a power saving mode as a panel driving mode for driving the display panel, and to control the first scan driver, the second scan driver, and the data driver based on the panel driving mode,
wherein the first through (N)th additional stages is configured to progressively output the scan signal in the normal driving mode, and a (2K−1) additional stage and a (2K) additional stage is configured to simultaneously output the scan signal in the power saving mode, where K is an integer between 1 and N/2.

20. The display device of claim 19, wherein a first additional stage is configured to receive a first carry signal from a last stage of the normal stages, and
wherein a second additional stage is configured to receive the first carry signal in the power saving mode, and receives a second carry signal from the first additional stage in the normal driving mode.
